(19) United States
(12) Patent Application Publication
(10) Pub. No.: US 2009/0133007 A1
(43) Pub. Date: May 21, 2009

(54) COMPILER AND TOOL CHAIN

(76) Inventor: Makoto Satoh, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/269,966

(22) Filed: Nov. 13, 2008

(30) Foreign Application Priority Data
Nov. 13, 2007 (JP) 2007-294046

(51) Int. Cl. G06F 9/45

(52) U.S. Cl. 717/149

(57) ABSTRACT

A compiler for a DRP inputs a source program, and outputs the final CPU code to operate in an information processing device having hierarchical memories of at least three hierarchies comprising addressable memories. The compiler outputs a code which transfers instructions or configurations to a processor of the information processing device, in the hierarchical memories, with the memory close to the processor as the upper layer, from the memory of the lower layer to the memory of the upper layer, step by step.

### CROSS-REFERENCE TO RELATED APPLICATION

The present application claims priority from Japanese Patent Application No. JP 2007-294046 filed on Nov. 13, 2007, the content of which is hereby incorporated by reference into this application.

### TECHNICAL FIELD OF THE INVENTION

The present invention relates to a compiler which inputs a source program, and outputs an object program and a tool chain including the compiler, in particular, it relates to a technology to generate an object program operated in a system having a hierarchical memory comprising an addressable memory.

### BACKGROUND OF THE INVENTION

Conventionally, as described in p. 33 of Non-Patent Document 1 (Sakakibara Yasushi, Sato Yumi, “Device Architecture of DAPDNA (trademark)”, Design Wave Magazine 2004 August, pp. 30-38), in a dynamically reconfigurable processor (DRP: Dynamically Reconfigurable Processor), two hierarchies of memories (a main memory, and four registers in each processor element) for the configuration storage of each processor element are employed, and configuration for all the processor elements, namely, a fixed size of configuration data is transferred from the main memory to the respective registers for every function to be dynamically reconfigured.

Further, conventionally, as described in Non-Patent Document 2 (Hennesy and Patterson, “Computer architecture a quantitative approach”, Margin Kaufmann, 1996), there has been a processor using a cache of multiple hierarchies. In addition, as described in p, 403 of Non-Patent Document 3 (Tomoyuki Kodama, Takanobu Tsunoda, Masashi Takada, Hiroshi Tanaka, Yohei Akita, Makoto Sato, and Masaki Ito, “Flexible Engine: A Dynamic Reconfigurable Accelerator with High Performance and Low Power Consumption”, in Proceedings of IEEE Symposium on Low-Power and High-Speed Chips (COOL Chips IX), Yokohama, Japan, Apr. 19-21, 2006, pp. 393-408), there has been a system that has a Configuration Data Buffer which is a memory to store the configuration for each processor element in a dynamically reconfigurable processor, and a memory which stores a Transfer Control Table which indicates a plurality of configurations in the memory, and the configurations are transferred to a Configuration Data Register in each processor element.

### SUMMARY OF THE INVENTION

In the conventional art mentioned in the Non-Patent Document 1, because configurations for all the processor elements are always transferred from the main memory on the occasion of a transfer of the configuration for each function, and accordingly, the transfer quantity increases, and the transfer time becomes long. Also, in the conventional art mentioned in the Non-Patent Document 2, even if data necessary for the technology such as pre-fetch is put on a cache beforehand, because there may not be data on the cache when it is necessary, there might be a fear of processing performance degradation. Further, in the conventional art mentioned in the Non-Patent Document 3, a hierarchical memory to support a data common use is provided as hardware, but the means to use this as software effectively is not disclosed therein.

Accordingly, an object of the present invention is to provide a technology to make a software program which performs the transfer of instructions and configurations at a high speed and efficiently, in a system having a hierarchical memory comprising addressable memories.

The above and other objects and novel characteristics of the present invention will be apparent from the description of this specification and the accompanying drawings.

The typical ones of the inventions disclosed in this application will be briefly described as follows.

A compiler according to a representative embodiment of the present invention is a compiler that inputs a source program, and outputs an object program to operate in an information processing device having hierarchical memories of at least three hierarchies comprising addressable memories, where a code for transferring instructions or configurations to a processor of the information processing device is outputted, with taking the memory close to the processor as the upper layer in the hierarchical memories, from the memory of the lower layer to the memory of the upper layer, step by step.

The effects obtained by typical aspects of the present invention will be briefly described below.

According to a representative embodiment of the present invention, since it is possible to use the hierarchical memory effectively at the time of running the object program, without controlling the cache in software, in accelerators such as a DRP and the like having the addressable hierarchical memory, it is possible to reduce an overhead on the load of instructions and configurations as much as possible, and keep the high speed processing performance of the accelerators to the maximum.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing the constitution of a compiler for a DRP according to an embodiment of the present invention;

FIG. 2 is a diagram showing a hardware constitution example of a computer system in which a compiler for a DRP according to an embodiment of the present invention operates;

FIG. 3 is a diagram showing a hardware constitution example of an information processing device in which a final CPU code operates, in an embodiment of the present invention;

FIG. 4 is a diagram showing a constitution example of a processor element, in an embodiment of the present invention;

FIG. 5 is a diagram showing an example of the relation between a CM and a TM, in an embodiment of the present invention;

FIG. 6 is a diagram showing a hierarchical memory in the constitution of an LSI, in an embodiment of the present invention;

FIG. 7 is a flow chart showing a flow of the process of a code generation unit for a hierarchical memory, in an embodiment of the present invention;

FIG. 8 is a flow chart showing a flow of the instruction transfer scheduling process, in an embodiment of the present invention;

FIG. 9 is a diagram showing an example of the source program to be inputted into a compiler for a DRP, in an embodiment of the present invention;

FIG. 10 is a diagram showing the example of the hierarchy thread graph for the one which made source program in an embodiment of the present invention a thread in;

FIG. 11 is a diagram showing an example of the data structures to practically express a hierarchy thread graph, in an embodiment of the present invention;

FIG. 12 is a diagram showing an example of coordinates established for each processor element in a processor array, in an embodiment of the present invention;

FIG. 13 is a diagram showing a sign to express the direction of a wire to connect a certain processor element and another processor element surrounding the same, in an embodiment of the present invention;

FIG. 14 is a diagram showing a thread code in which each loop of a source program is expressed by use of an assembler description, in an embodiment of the present invention;

FIG. 15 is a diagram showing examples (a), (b), and (c) in which a thread code is mapped in a processor array, in an embodiment of the present invention;

FIG. 16 is a diagram showing an example of an intermediate CPU code for a source program, in an embodiment of the present invention;

FIG. 17 is a diagram showing an example of the data structure to express a hierarchy thread graph and a thread interval graph, in an embodiment of the present invention;

FIG. 18 is a diagram showing an example of the thread interval graph for an RF, in an embodiment of the present invention;

FIG. 19 is a diagram showing an example of the thread interval graph of the result of scheduling for a load instruction in the RF, in an embodiment of the present invention;

FIG. 20 is a diagram showing an example of the thread interval graph for the TM, in an embodiment of the present invention;

FIG. 21 is a diagram showing an example of the thread interval graph of the result of scheduling for the load instruction in the TM, in an embodiment of the present invention;

FIG. 22 is a diagram showing an example of the thread interval graph for a CM at the time point of allotment of memory units, in an embodiment of the present invention;

FIG. 23 is a diagram showing an example of the thread interval graph of the result of scheduling for a load instruction in the CM, in an embodiment of the present invention;

FIG. 24 is a diagram showing a thread interval graph in which a thread interval graph for the CM and a thread interval graph for the TM are integrated, in an embodiment of the present invention;

FIG. 25 is a diagram showing the final CPU code outputted on the basis of the thread interval graph, in an embodiment of the present invention; and

FIG. 26 is a diagram showing an example of a sequencer code in which the contents of each entry of a sequencer memory are described in the form of a sentence, in an embodiment of the present invention.

### DESCRIPTIONS OF THE PREFERRED EMBODIMENTS

Hereinafter, embodiments of the present invention will be described in detail with reference to the accompanying drawings. Note that, components having the same function are denoted by the same reference symbols throughout the drawings for describing the embodiment, and the repetitive description thereof will be omitted.

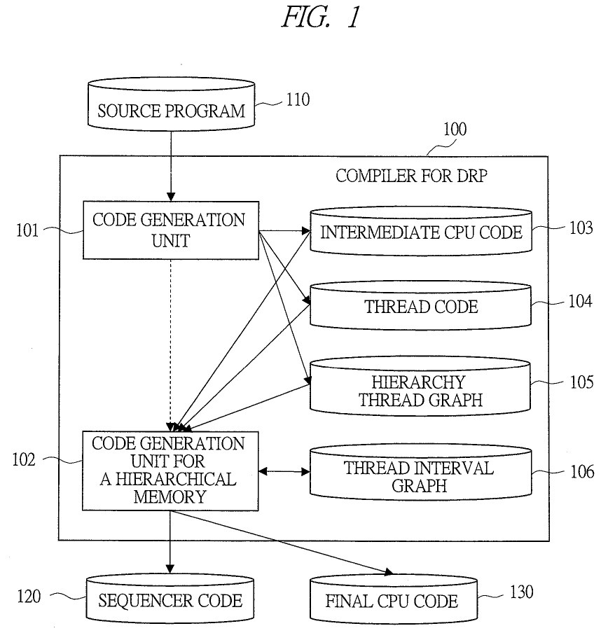

FIG. 1 is a diagram showing the constitution of a compiler for a DRP (dynamically reconfigurable processor) according to an embodiment of the present invention. A compiler 100 for a DRP is comprised of a code generation unit 101 and a code generation unit 102 for a hierarchical memory, and, with a source program 110 as an input, it generates and outputs a sequencer code 120 which is an object program executable by a processor, and the final CPU code 130.

The code generation unit 101 inputs a source program 110, and in a form to read an instruction directly from a main memory, without being conscious of a hierarchical memory to be mentioned later herein, generates and outputs an intermediate CPU code 103, a thread code 104, and a hierarchy thread graph 105. Because the processing in the code generation unit 101 is similar to the processing in the general compiler, the explanation about the processing contents is omitted herein.

The code generation unit 102 for a hierarchical memory inputs the intermediate CPU code 103, the thread code 104, and the hierarchy thread graph 105 which the code generation unit 101 outputs, and processes them by use of the thread interval graph 106, and generates and outputs a sequencer code 120 and the final CPU code 130, in a form of being conscious of the hierarchical memory. The processing contents in the code generation unit 102 for a hierarchical memory is mentioned later herein.

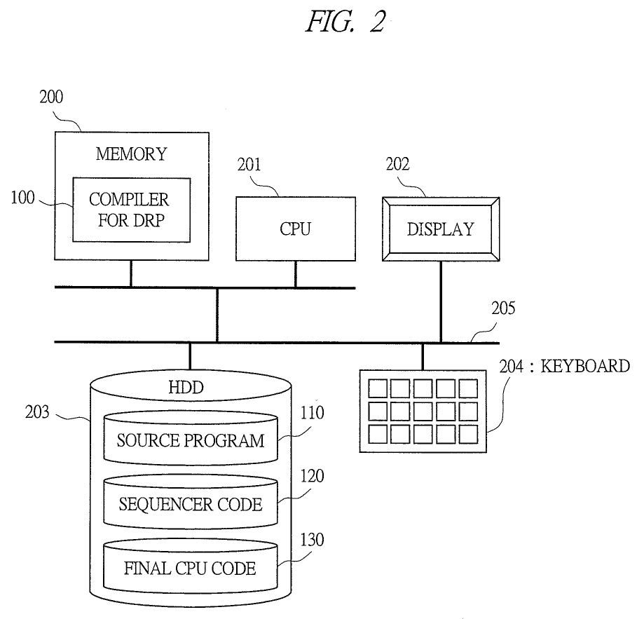

FIG. 2 is a diagram showing a hardware constitution example of a computer system in which the compiler 100 for a DRP of FIG. 1 operates. The computer system has a memory 200, a CPU 201, a display 202, an HDD (hard disk drive) 203, and a keyboard 204, and these are connected to a bus 205. The source program 110 stored in the HDD 203 is inputted into the compiler 100 for a DRP that is stored in the memory 200 and operates on the CPU 201, and the sequencer code 120 and the final CPU code 130 output from the compiler 100 for a DRP are stored in the HDD 203.

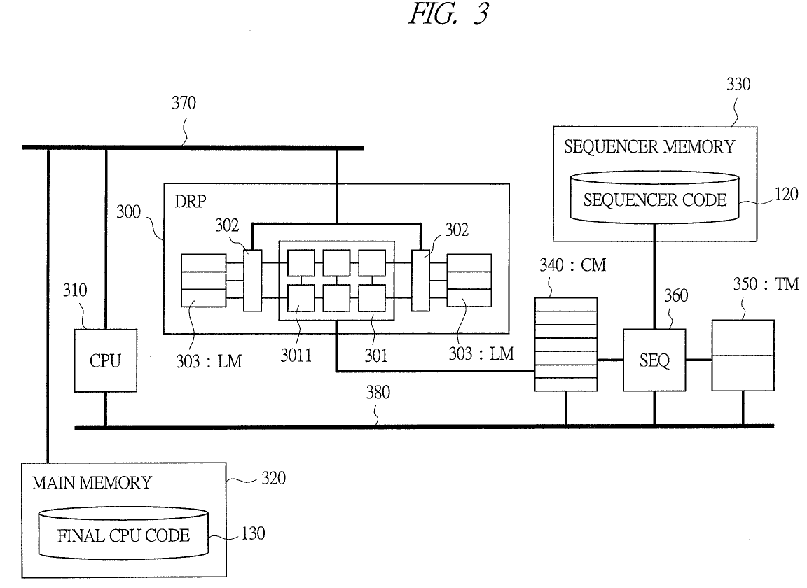

FIG. 3 is a diagram showing a hardware constitution example of an information processing device in which the sequencer code 120 and the final CPU code 130 outputted from the compiler 100 for a DRP of FIG. 1 operate. This information processing device is packaged as, for example, an LSI, and it has a constitution having a DRP (dynamically reconfigurable processor) 300, a CPU310, a main memory 320, a sequencer memory 330, a CM 340, a TM 350, a sequencer (SEQ) 360, a bus 370 for data transfer, and a bus 380 for configuration transfer.

The DRP 300 becomes the constitution further having a processor array 301, crossbar networks 302, and local data memories (LM) 303. The processor array 301 is comprised of a plurality of processor elements 3011, and the respective processor elements 3011 are connected by wires in the vertical direction and the horizontal direction as shown in the diagram. The local data memories 303 become the constitution of six banks in total by three banks in left and right in the present embodiment, the left and right data memories 303 are connected to the processor elements 3011 at the left end and the right end of the processor array 301 respectively via the crossbar networks 302.

The sequencer 360 is a sequencer to control the operation of the DRP 300, and the sequencer memory 330 is a memory for the sequencer 360 and stores the sequencer code 120. In addition, the CM 340 is an addressable memory for pooling instructions to store a cell configuration, that is, a configuration for each processor element 3011 (cell), and has a constitution having seven banks in the present embodiment. Further, TM350 is an addressable memory for an instruction block table to store a thread table, that is, the program (instruction) of one thread to operate on the processor array 301. The CM 340, and the TM 350 become the elements constituting hierarchical memories whose details are mentioned later herein.

Herein, the final CPU code 130 stored in the main memory 320, first, transfers a thread table to the TM 350, and transfers a cell configuration to the CM 340. Next, the sequencer code 120 stored in the sequencer memory 330, by use of the thread table and the cell configuration, loads the cell configuration to the processor elements 3011 and controls the operation of the DRP 300. In this manner, the transfer of data is performed from the main memory 320 to the processor elements 3011 step by step.

FIG. 4 is a diagram showing a constitution example of the processor element 3011 of FIG. 3. The processor element 3011 becomes the constitution having a DLY 401, an ALU 402, an MUL 403, switches 405 and 407, an RF (register file) 408, and switches 409 and 412. The DLY 401 is a delay buffer to generate a delay of one cycle, and the ALU 402 is an arithmetic calculation device to perform arithmetic operations, and the MUL 403 is a multiplying device to perform multiplying operations.

The switch 405 selects from which wire 404 for data input the data is inputted, by the cell configuration, in other words, from which transfer direction of the processor element 3011 the data is inputted, the details of which will be mentioned later. Further, the switch selects a calculation device to operate the inputted data from the DLY 401, the ALU 402, and the MUL 403. The switch 407 selects the data that the processor element 3011 outputs, by the cell configuration, and selects to which wire 406 for data output the data is outputted, in other words, to which transfer direction of the processor element 3011 the data is outputted.

The RF 408 is a register file to store the cell configuration, and becomes the element constituting a hierarchical memory whose details are mentioned later herein. In the present embodiment, it is assumed to consist of two banks. The switch 409 selects the contents of one side of the RF 408 by the input from the sequencer 360 through a signal line 410. The switch 412 select to which RF 408 the cell configuration transferred through a signal line 411 from the CM 340 is inputted. By this constitution, two cell configurations can be stored to the RF 408, and the processor element 3011 can select two kinds of operations by these, and therefore can perform two kinds of dynamic reconfigurations at a high speed.

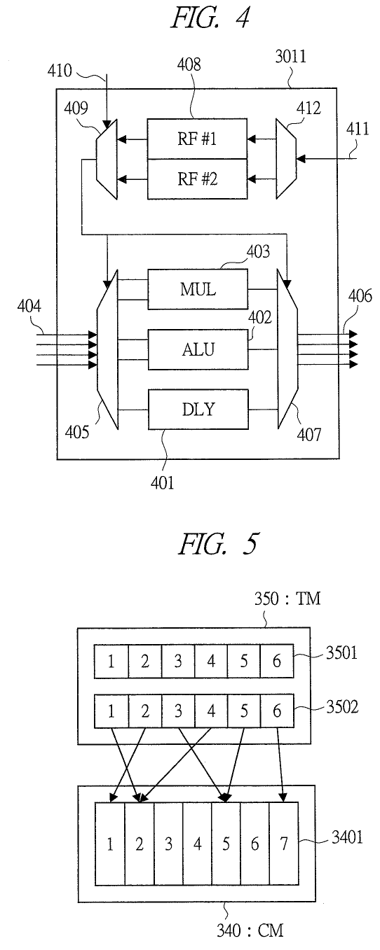

FIG. 5 is a diagram showing an example of the relation between the CM 340 and the TM 350. In FIG. 5, to the CM 340, seven cell configurations 3401 are stored as the cell configurations of the respective processor elements 3011. In addition, to the TM 350, instruction block tables 3501 and 3502 are stored, and the instruction block tables 3501 and 3502 have six elements respectively. The respective elements become the fields corresponding to the six processor elements 3011.

In the respective fields of the instruction block tables 3501 and 3502, a pointer indicating one of the seven cell configurations 3401 is stored. Therefore, by use of the instruction block table 3501 or 3502, and the signal line 411 and the switch 412 of FIG. 4, it is possible to transfer each cell configuration 3401 to each corresponding processor element 3011.

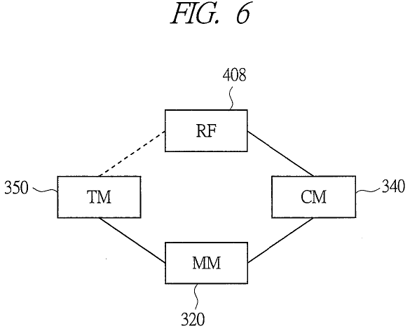

FIG. 6 is a diagram showing hierarchical memories in the constitution of the LSI of FIG. 3. The MM in the diagram shows the main memory 320. The dashed line linking the memories shows that data is not transferred directly between the object memories (for example, between the TM 350 and the RF 408), but the control of data transfer is applied. In addition, the solid line linking the memories shows that data is transferred directly between the object memories (for example, between the CM 340 and the RF 408).

In the hierarchical memories, the memory close to the processor (processor element 3011 in the case of the dynamically reconfigurable processor of the present embodiment) is made an upper layer. Therefore, in the case of the LSI of FIG. 3, a constitution having hierarchical memories of three hierarchies in which the RF 408 is on the top layer, and the CM 340 and the TM 350 are on the lower layer, and the main memory 320 is on the further lower layer is formed. In addition, in the present embodiment, the hierarchical memories are three hierarchies, but the present invention is not limited to this, and hierarchical memories having more than three hierarchies may be employed.

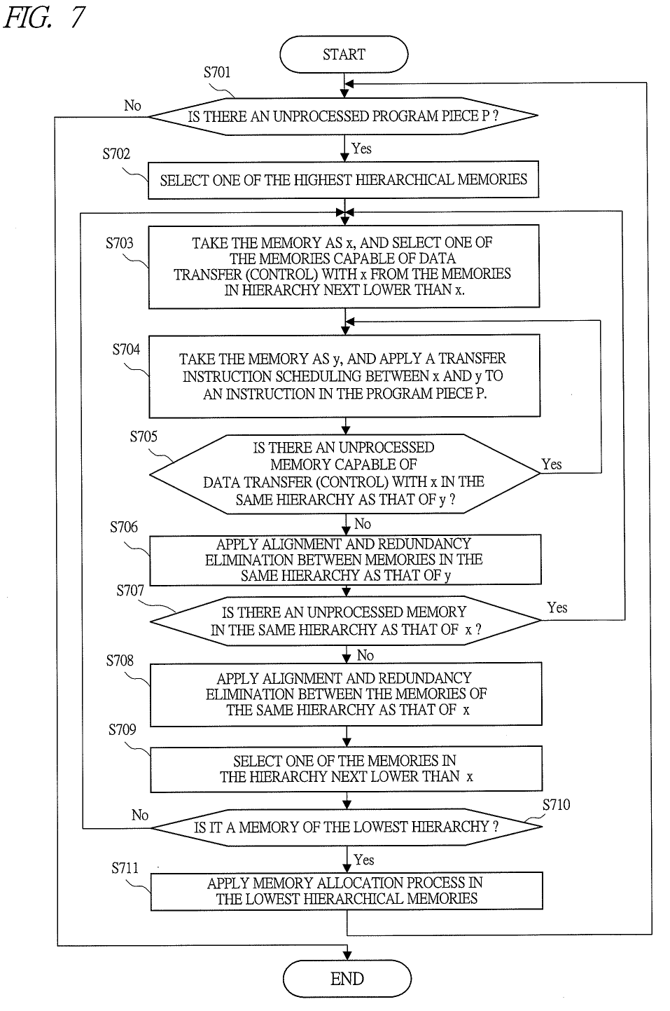

In the following, the contents of the process in the code generation unit 102 for a hierarchical memory of FIG. 1 are explained. FIG. 7 is a flow chart showing a flow of the process of the code generation unit 102 for a hierarchical memory. First, at step S701, it is judged whether there is an unprocessed program piece P among the intermediate CPU code 103 or not. If there is an unprocessed program piece P, the process goes on to step S702, and if there is not any, the process is finished.

At the step S702, one of the hierarchical memories on the top layer, which is closest to the processor, is selected. Next, at step S703, the memory which is selected at the step S702 is made x, and among memories of the lower layer than x, one of the memories in which the data transfer is possible with x, or the memories that control the data transfer between x and other memories is selected.

Herein, the latter memory is, for example, the memory that is different from the memory that holds data to be transferred to x (hereinafter referred to as z) and holds an address on x to transfer the data (hereinafter referred to as w) and the like. Because in the real data transfer, both w and z are used at the same time, and in the present embodiment, memories such as w are handled in the same manner as memories in which the data transfer is possible with x. The TM 350 is an example of such memories.

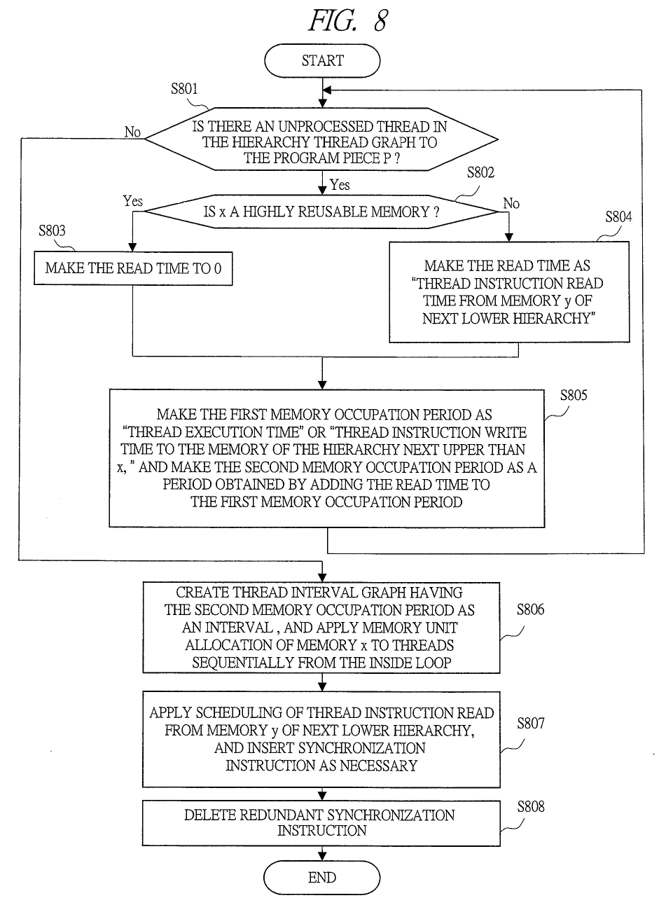

Next, at step S704, the memory which is selected at the step S703 is made y, and an instruction transfer scheduling between x and y is made to an instruction in the program piece P. The details of the instruction transfer scheduling process at the step S704 are explained with reference to FIG. 8.

FIG. 8 is a flow chart showing a flow of the instruction transfer scheduling process. First, at step S801, it is judged whether there is an unprocessed thread in the hierarchy thread graph 105 to the program piece P. The details of the hierarchy thread graph 105 are mentioned later herein. If there is an unprocessed thread, the process goes on to step S802 and if there is not any unprocessed thread, the process goes on to step S806.

At step S802, it is judged whether x is a highly reusable memory or not, and if it is a highly reusable memory, the process goes on to step S803, and otherwise, the process goes on to step S804. Herein, a highly reusable memory means a memory that holds data of a high possibility to be processed many times, and means a memory of a high possibility that data to be referred to for a time period during program processing exists on the memory.

For example, the memory maintaining data and configurations with a possibility to be used in common by the plural processor elements 3011 is considered as a highly reusable memory, and the memory maintaining data to be used separately by plural processor elements 3011 is considered as a lowly reusable memory. In addition, the judgment whether the reusability is high or low is a rough standard, and even if this judgment is different, no error occurs in the result of the instruction transfer scheduling process, and just the processing performance of the program that the compiler 100 for DRP outputs changes. Actually, this judgment will different depending on a hardware system and a compiler design, and it is thought that there is such a memory which is difficult to be distinguished.

At step S803, a read time to be used in following process is made 0. This is a model that there is no need to read data from the lower layer memory, because there is a high possibility that there are data to be referred to in the memory. On the other hand, at step S804, the read time is made “the thread instruction read time from the memory y of the lower layer”. This is a model that it is necessary to read data from the lower memory, because the possibility that there are data to be referred to in the memory is low.

At step S805, the first memory occupancy period is made “thread execution time” or “thread instruction write time to the memory of the upper layer of x”, and the second memory occupancy period is made the period obtained by adding the read time to the first memory occupancy period. For example, in the case of the hierarchical memory of FIG. 6, the “thread execution time” is used when x is the TM 350 to store the program of the thread. On the other hand, “thread instruction write time to the memory of the upper layer of x” is used when x is the CM 340 to store the cell configuration 3401.

Next, at step S806, the thread interval graph 106 is prepared with the second memory occupancy period as an interval, and memory units of memory x are allotted to threads sequentially from the inside loop. Herein, the thread interval graph is what is defined in “Constitution and Optimization of the Compiler, written by Ikuo Nakata, Asakura Bookstore, p. 384”, and it is often used in the register allotment processing.

Next, at step S807, the thread instruction read scheduling from the memory y of the lower layer is performed, and a synchronization instruction is inserted when it is necessary. Herein, the scheduling is what is defined in “Constitution and Optimization of the Compiler, written by Ikuo Nakata, Asakura Bookstore, p. 358”, and it is often used in the optimization processing of instructions to the CPU. In addition, the synchronization instruction is the process that is inserted in order to wait for the use end of the memory unit, in cases such as to avoid overwriting to a memory unit now in use.

Finally, at step S808, a redundant synchronization instruction is deleted. For example, when there are plural synchronization instructions in one place, the instructions are deleted to one synchronization instruction. With the above, the instruction transfer scheduling process is finished, and the process goes back to the step S705 of FIG. 7.

At the step S705, it is judged whether there is an unprocessed memory that can perform the data transfer with x or the control of the data transfer in the same hierarchy as that of y. If there is an unprocessed memory, the step S704 is carried out again, and if there is not any, the process goes on to the step S706.

At step S706, alignment redundancy elimination is applied between the memories of the same hierarchy as that of y. Herein, when there are plural memories to store similar data, it is judged whether there are data redundant between them or not, and when there are redundant or duplicated data, only one is left if possible, and the other is deleted. At this moment, the combination of the memory occupancy period and the synchronization instruction of both the data is made the memory occupancy period and the synchronization instruction of the left data, and alignment is taken so that there is no problem or contradiction in the data transfer and the like.

Next, at step S707, it is judged whether there is an unprocessed memory of the same hierarchy as that of x. If there is one, the process goes back to step S703, and if there is not any, the process goes on to step S708. At the step S708, alignment redundancy elimination is applied between the memories of the same hierarchy as that of x. The processing contents herein are similar to those at the step S706.

Next, at step S709, one of the memories of the hierarchy lower than that of x by one layer is selected. At step S710, it is judged whether the memory selected at the step S709 is the memory of the lowest hierarchy or not. If it is not the memory of the lowest hierarchy, the process goes back to the step S703, and if it is the memory of the lowest hierarchy, the process goes on to step S711. Finally, at step S711, a memory allocation process is applied in the lowest hierarchical memories.

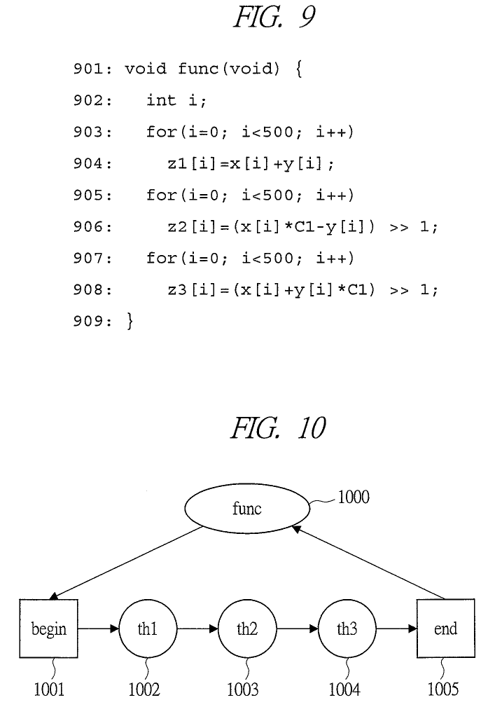

Hereinafter, about a real program example, how the process is performed in the code generation unit 102 for hierarchical memory is explained. FIG. 9 is a diagram showing an example of a source program 110 to be inputted into a compiler 100 for a DRP of the present embodiment. Sentence 903 and sentence 904, sentence 905 and sentence 906, and sentence 907 and sentence 908 show a loop respectively. In a DRP 300 in the present embodiment, the execution of each loop is mapped onto a processor array 301 each as a thread.

FIG. 10 is a diagram showing an example of a hierarchy thread graph 105 to what the source program 110 of FIG. 9 is made into a thread. Node 1000 is a node corresponding to the function “func” of sentence 901 of FIG. 9. Node 1001 shows the first node to the hierarchy under the node 1000. This is the node arranged for convenience of the processing, and there is not the sentence corresponding to this in the source program 110 of FIG. 9.

Node 1002 is a node corresponding to the thread into which the loops which the sentence 903 of FIG. 9 and the sentence 904 show are converted. In addition, node 1003 is a node corresponding to the thread into which the loops which the sentence 905 and the sentence 906 show are converted. Node 1004 is a node corresponding to the thread into which the loops which the sentence 907 and the sentence 908 show are converted in the same manner. Node 1005 shows the last node to the hierarchy under the node 1000. This is the node that arranged for convenience of the processing, and there is not the sentence corresponding to this in the source program 110 of FIG. 9.

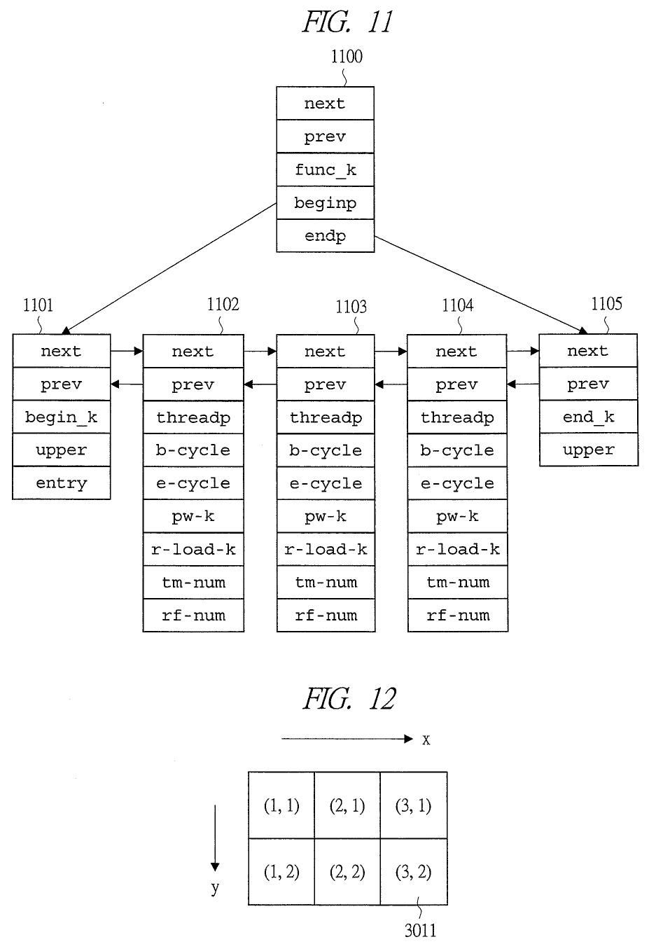

FIG. 11 is a diagram showing an example of the data structure to really express the hierarchy thread graph 105 of FIG. 10. Table 1100 is a table corresponding to the node 1000 of FIG. 10. Herein, a “next” field and a “prev” field show pointers to the just previous and just next tables in the same hierarchy. In the example of FIG. 10, the node 1000 is a node to express a function, and because there is not any node of the same hierarchy as this, these values become NULL. The flag “func_k” shows that this table 1100 is a table for the function. The “beginp” field shows the pointer to first table 1101 of the thread graph of the hierarchy lower than the table 1100. The “endp” field shows the pointer to the last table 1105 of the thread graph of the hierarchy lower than the table 1100.

Table 1101 is a table corresponding to the node 1001 of FIG. 10, and is the first table in the thread graph of this hierarchy. The flag “begin_k” shows it. The upper field shows a pointer to the table 1100 connected to this hierarchy in the upper hierarchy. As examples of other hierarchies than the hierarchy thread graph 105 of FIG. 11, there are a loop or an “if” sentence and the like. In other words, the table corresponding to the loop and the if sentence become the upper hierarchy, and each sentence in the loop and the “then” side and the “else” side of the if sentence become the lower hierarchy. At this moment, the “upper” field included in the first table of the sentence in the loop becomes a pointer to the table expressing a loop, and the upper field included in the first table of the sentence of the then side becomes a pointer to a table expressing the if sentence. The “entry” field shows a pointer to a thread interval graph 106 to be mentioned later.

Table 1102 is a table corresponding to the node 1002 of FIG. 10. Herein, the “threadp” field shows a pointer to the thread code. The “b-cycle” field shows the start cycle of this thread. It is assumed that the cycle of the table just after the first table 1101 is 0. The “e-cycle” field shows the cycle at the time of the execution end of this thread.

The flag “pw-k” is a flag to show whether either of a post process or a wait process is performed, or both the processes are performed. The post process is a process to tell some object about the end of this thread, and the wait process is a process to wait for the end of some object. The flag “r-load-k” is a flag showing whether the configuration in the TM 350 is transferred to the RF 408 at the same time with the thread execution start. The “tm-num” field shows a memory bank number in the TM 350 used by above transfer. The “rf-num” field shows a register number in the RF 408 used by above transfer.

The table 1103 is a table corresponding to the node 1003 of FIG. 10, and the table 1104 is a table corresponding to the node 1004 of FIG. 10. The contents of these tables are similar to those of the table 1102 mentioned above. The table 1105 is a table corresponding to the node 1005 of FIG. 10, and is the last table in the thread graph of this hierarchy. The flag “end_k” shows it.

Next, the arrangement of the respective processor elements 3011 in the processor array 301 and the transfer directions of data are explained. FIG. 12 is a diagram showing an example of coordinates which are established to the respective processor elements 3011 in the processor array 301. The x-axis, and the y-axis are defined to six processor elements 3011 as shown in the example of FIG. 12, and it is possible to specify the processor elements 3011 by the coordinates.

FIG. 13 is a diagram showing signs to express the directions of the wire to connect a certain processor element 3011 and other processor elements 3011 surrounding the same. These signs are applied to both the input to the processor element 3011 and the output therefrom, and can express the transfer directions of data. For example, the sign “u” is applied to the input wire from the processor element 3011 located above, and the sign “u” is also applied to the output wire to the processor element 3011 located above. In the same manner, the sign “d” is used to the input and output with the processor element 3011 located below, and the sign “l” is used to the input and output with the processor element 3011 located in the left, and the sign “r” is used to the input and output with the processor element 3011 located in the right.

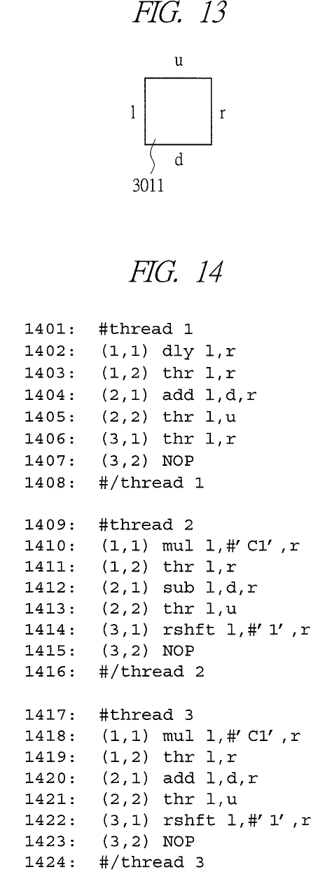

FIG. 14 is a diagram showing a thread code in which each loop of the source program 110 of FIG. 9 is expressed by use of an assembler description, on the basis of the designation method of the arrangement of the processor elements 3011 and the transfer directions of data explained above. The “#thread” of sentence 1401 shows the start of the thread, and the number after that shows a thread number. In addition, the #/thread of sentence 1408 shows the end of the thread. Therefore, the sentence surrounded by the sentence 1401 and the sentence 1408 becomes an assembler code corresponding to the thread 1, and the sentence surrounded by the sentence 1409 and the sentence 1416 becomes an assembler code corresponding to the thread 2, and the sentence surrounded by the sentence 1417 and the sentence 1424 becomes an assembler code corresponding to the thread 3.

In the sentence 1402, the first “(1, 1)” expresses the coordinate of the processor element 3011 in which this instruction is applied. This coordinate is set according to the example of FIG. 12 mentioned above. The “dly” after that expresses a delay instruction arranged to the processor element 3011 of this coordinate. The “dly l, r” expresses that data is inputted from the left direction (l), and outputted from the right direction (r). The data transfer direction is set according to the example of FIG. 13 mentioned above. For example, the sentence 1404 inputs data from the left and lower directions, and outputs an addition result (add) to the right direction. In addition, the “#‘Cl’” in the sentence 1410 shows an immediate value “Cl” stored in a buffer for delay. The above contents are applied to other sentences in the same manner.

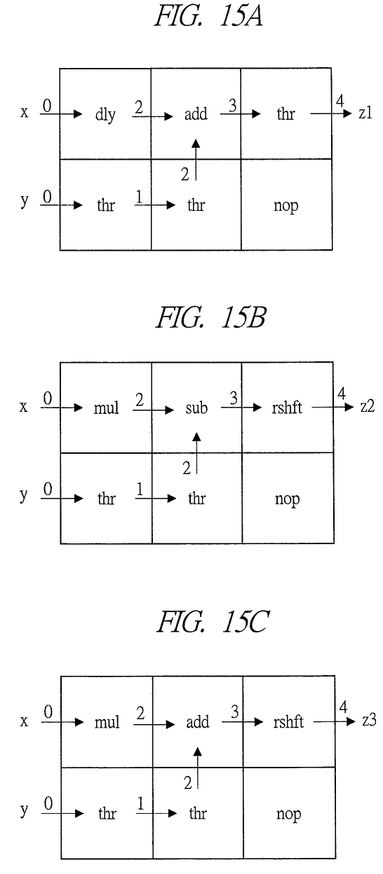

FIG. 15 is a diagram showing an example in which the thread code of FIG. 14 is mapped onto the processor array 301. The (a) of FIG. 15 shows the mapped result of the thread 1, (b) shows that of the thread 2, and (c) shows that of the thread 3 respectively. In (a), six rectangles show the processor elements 3011 respectively. In addition, x and y of the left of the diagram show the values x and y of the input arrangement, and z1 of the right side shows the value z1 of the output arrangement. In addition, the arrow in the diagram shows the data flow.

The “dly” shows one cycle delay, “add” shows an addition, and “thr” shows a data transfer without a delay, and “nop” shows doing nothing. The number described in the upper part of each arrow shows the number of progress cycles at the time point when the data transfer corresponding to the arrow is applied with the data input time point as 0 cycles. Because the data which arrives the processor elements 3011 at the same cycle are calculated, in the DRP 300 in the present embodiment, the calculation with the thread 1 will be performed correctly by this mapping. This is also same about (b), and (c) of FIG. 15. In addition, the “mul” in (b) means a multiplication, the “sub” means a subtraction, and the “rshft” shows a 1-bit shift to the right.

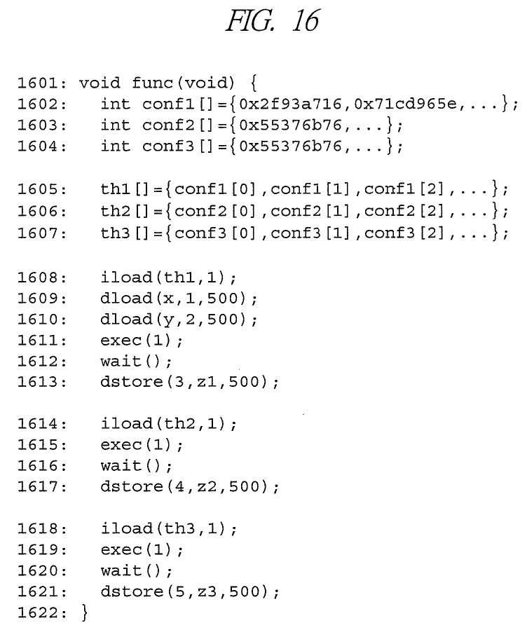

FIG. 16 is a diagram showing an example of the intermediate CPU code 103 to the source program 110 of FIG. 9. In the “confl” of the sentence 1602, the configuration of each processor element 3011 of the thread 1, namely, the thread codes from the sentence 1402 of FIG. 14 to the sentence 1407 are stored. In addition, the “th1” of the sentence 1605 shows that each configuration in the confl is referred to. In other words, by putting the confl in the CM 340, and putting the th1 in the TM 350, the preparations to load the configuration of the thread 1 to the processor array 301 are set.

The sentence 1608 expresses the process to store the cell configuration of cnfl to the first register of the RF 408 among the respective processor elements 3011 by use of the th1. In addition, the sentence 1609 expresses the process to load 500 elements of the arrangement “x” to the first bank of the local data memory 303. In the same manner, the sentence 1610 expresses the process to load 500 elements of the arrangement “y” to the second bank of the local data memory 303. The sentence 1611 expresses to start the execution of the DRP 300. In addition, the sentence 1612 expresses to wait for the completion of the execution of the DRP 300. The sentence 1613 expresses the process to store 500 elements of data in the third bank of the local data memory 303 to the arrangement “z1”. The above contents are applies to other sentences in the same manner.

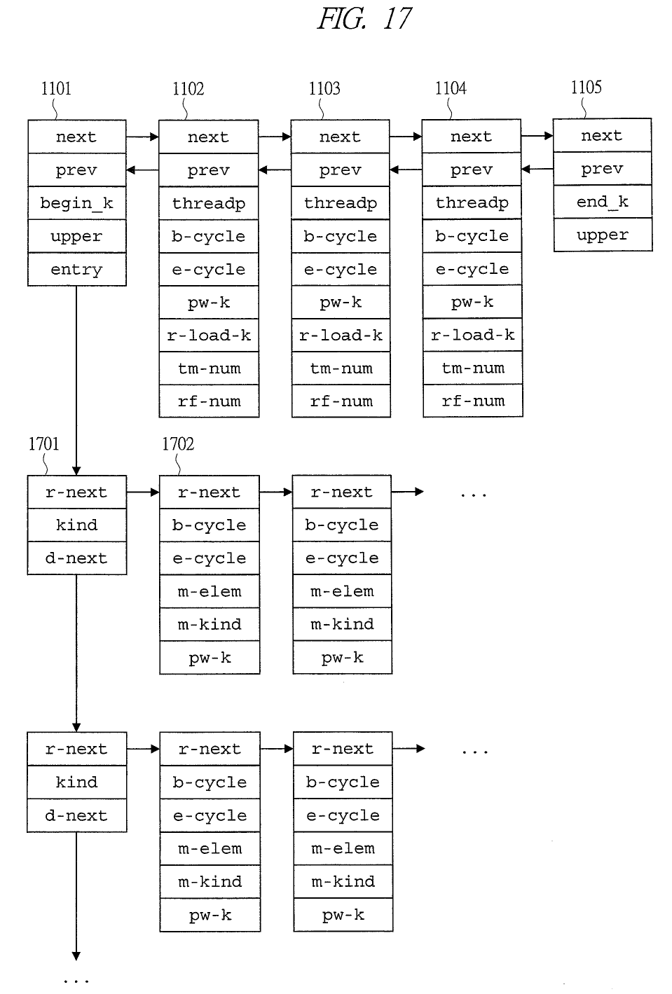

FIG. 17 is a diagram showing an example of the data structure to express the hierarchy thread graph 105 and the thread interval graph 106. The tables 1101 to 1105 are the respective tables shown in the data structure example of the hierarchy thread graph 105 of FIG. 11. Table 1701 is a table showing data such as the configuration and the like to be allotted to the memories such as the RF 408, the CM 340, the TM 350 and the like. Herein, the “r-next” field shows a pointer to the table 1702 which is a table related to this table. The “kind” field shows a data name such as a configuration name and the like. The “d-next” field shows a pointer to the table similar to the table 1701 corresponding to the other data name.

The table 1702 is a table to show which memory position the data name shown by the table 1701 at a certain cycle interval is assigned to. Herein, the r-next shows a pointer to the next table like the table 1702 corresponding to the same data name. The b-cycle shows the first cycle at which a certain data is assigned. The e-cycle shows the last cycle at which a certain data is assigned.

The “m-elem” shows the position in the memory to which a certain data is assigned. The m-kind shows the kinds (CM 340 and the like) of the memory to which a certain data is assigned. The pw-k is a flag to show whether either of a post process or a wait process is performed, or both the processes are performed. The post process is a process to tell some object about the end of this thread, and the wait process is a process to wait for the end of some object.

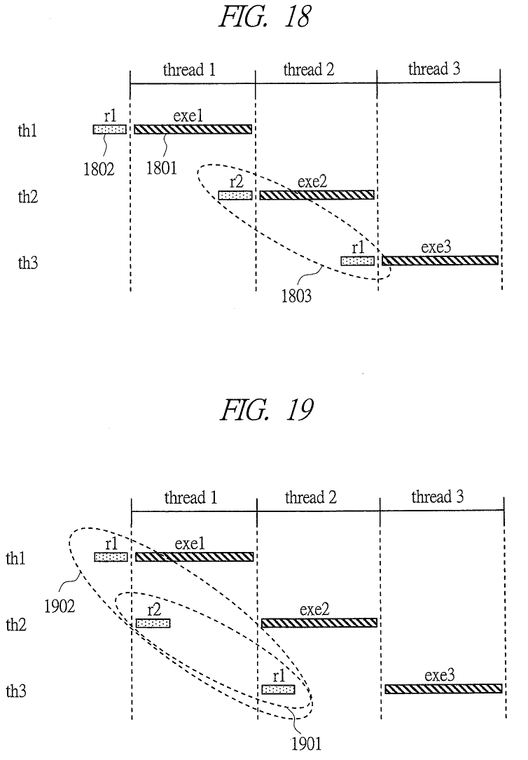

FIG. 18 is a diagram showing an example of the thread interval graph 106 to the RF 408 which is the memory of the top layer in the hierarchical memories of FIG. 6. This graph is a graph showing a thread and the execution period of the thread. Because explanations become complicated when it is described in the notation method of FIG. 17, for convenience of the explanations, it is explained in the notation method such as in FIG. 18 hereinafter.

In FIG. 18, the horizontal axle is a time axis expressing the progress of the number of the execution cycles of the thread. The time axis is divided into periods, and the thread numbers (thread 1 to thread 3) of the thread applied in the periods concerned are shown on the time axis. In the example of FIG. 18, it is divided into three periods, and the respective periods correspond to three hierarchies (tables 1102 to 1104) in the example of the hierarchy thread graph 105 of FIG. 17.

The interval 1801 shows the interval where the thread 1 is applied. In this case, the data name corresponding to the execution of the thread 1 is th1, and shows that the object is a thread table, namely, the th1 of the sentence 1605 of FIG. 16. The interval 1802 requires the time to transfer the configuration to the RF 408 by use of the TM 350 and the CM 340 before the execution of the thread 1, and the number of the cycles thereof is shown as the “read” interval. This is similar to the thread 2, and the thread 3 hereinafter.

On the basis of the examples of FIG. 6 and FIG. 18, the contents of the process shown in FIG. 7 and FIG. 8 are explained concretely as follows. First, at the step S702 of FIG. 7, the RF 408 which is the highest memory is selected. Next, at the step S703, the RF 408 is made x, and the TM 350 which is the memory of the hierarchy under that of the RF 408 is selected. Next, at the step S704, the TM 350 is made y, and the process goes to the process of FIG. 8.

First, at step S802, because the RF 408 which is x is a lowly reusable memory, the process goes to step S804, and the read time is made the interval 1802 in FIG. 18 which is the load time of data from the TM 350 to the RF 408 (as mentioned previously, the direct data transfer is not performed between the TM 350 and the RF 408, but for convenience of the explanation, the description is made in this way, and this is same hereinafter). Furthermore, at step S805, the first memory occupancy period is made the interval 1801 in FIG. 18 which is the thread execution period of the RF 408, and the second memory occupancy period is made the interval obtained by adding the interval 1801 and the interval 1802 of FIG. 18 together.

Next, at step S806, as the allotment of the memory units, since the number of registers of the RF 408 is two, the number 1 or 2 is allotted to each read interval. The characters “r1” and “r2” mentioned in each read interval of FIG. 18 express the allotment result, and, the r1 shows that read is made to the first register of the RF 408, and the r2 shows that read is made to the second register of the RF 408. Thereafter, the scheduling for each read processing is performed at step S807. The graph representing the result is shown in FIG. 19.

FIG. 19 is a diagram showing an example of the thread interval graph 106 of the result of the scheduling of the load instruction in the RF 408. In the DRP 300 in the present embodiment, as explained in FIG. 11, it is characteristic that it is possible to load data to the RF 408 at the same time with the thread execution start. The result of the movement of the load instruction to the read interval 1803 of FIG. 18 in consideration of this characteristic is the read interval 1901 of FIG. 19. In other words, two read processes r1 and r2 are performed at the same time with the execution start of the thread.

Next, the process of FIG. 8 is finished, and the process goes back to the step S705 of FIG. 7. From FIG. 6, the TM 350 and the CM 340 equivalent to y are on the same hierarchy, but because both the memories operate in cooperation, in this case, they are considered to be one memory. Therefore, there is not other unprocessed memory on this hierarchy. Next, the process goes to step the S706, but because the hierarchy of y has only one memory, there is no need to perform the alignment redundancy elimination.

At the steps S707 and S708, because the memory of the hierarchy of x is only the RF 408, the process is not performed. At the step S709, the TM 350 is selected as the memory of the hierarchies under x, and at the step S710, the process goes back to the step S703 because the TM 350 is not the lowest hierarchical memory. At the step S703, the TM 350 is made x, and the main memory 320 is selected as the memory of the lower hierarchy. At the step S704, the main memory 320 is made y, and the process goes on to the process of FIG. 8.

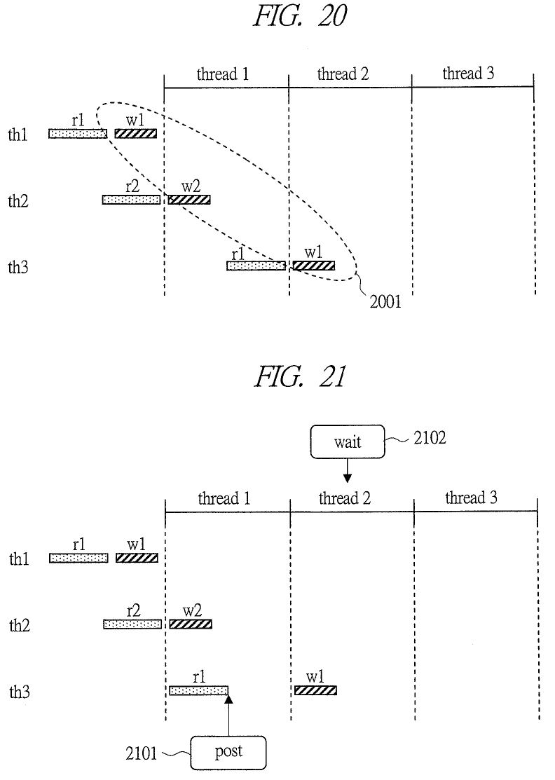

At step S802, because the TM 350 which is x is a lowly reusable memory, at step S804, the read time from the main memory 320 to the TM 350 is considered. Next, at step S805, the read time from the TM 350 of the RF 408 in FIG. 19 becomes the write time from the TM 350 to the RF 408 from the viewpoint of the TM 350, and accordingly it corresponds to the thread execution interval of the TM 350. The graph representing this is shown in FIG. 20.

FIG. 20 is a diagram showing an example of the thread interval graph 106 to the TM 350. By the process of the step S805, the read interval 1902 of FIG. 19 becomes the write interval 2001 in FIG. 20. In addition, because the TM 350 is a lowly reusable memory, it is necessary to consider the read time from the main memory 320, and the read interval is added. At step S806, because the number of memory banks of the TM 350 is two, one of the two memories is allotted to each read interval. The characters r1 and r2 allotted to each read interval of FIG. 20 show the allotment result. Thereafter, the scheduling is applied at the step S807.

FIG. 21 is a diagram showing an example of the thread interval graph 106 of the result of the scheduling of the load instruction in the TM 350. The post process 2101 performs the post process at the time of the end of the read interval corresponding to the thread of “th3”, and the wait process 2102 performs the wait process at the time of the start of the thread 2. After confirming that the post process 2101 is completed by this wait process 2102, the write from the TM 350 to the RF 408 is started, and accordingly, it is guaranteed that the configuration of the thread 3 is in the RF 408 at the time of the execution of the thread 3 by the processor array 301.

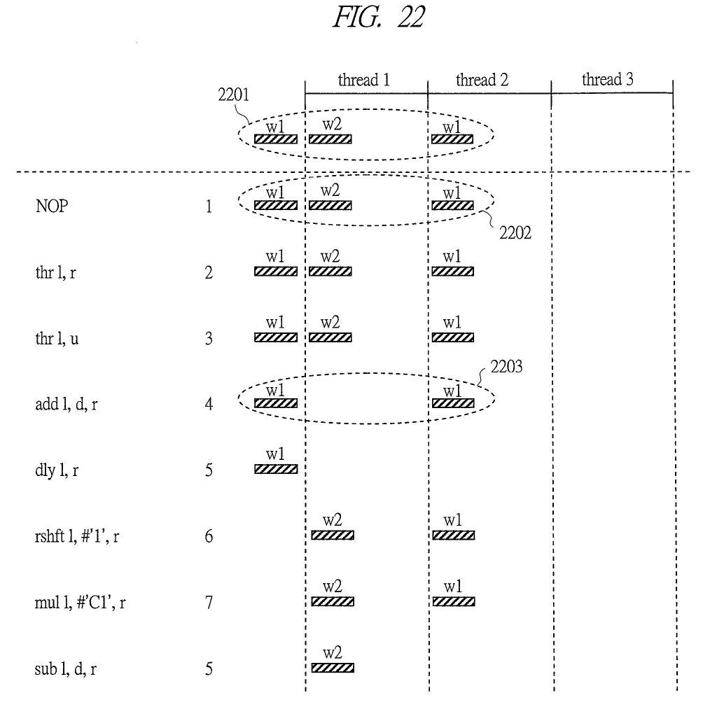

Next, in the same manner as the TM 350, the CM 340 is made x in the process of FIG. 7, the main memory 320 is made y and the process goes to the process of FIG. 8. FIG. 22 is a diagram showing an example of the thread interval graph 106 to the CM 340 at the time point when the allotment of the memory units is performed at the step S806. The instructions at the left end of the diagram show instructions supplied to the processor element 3011. The numbers described in the right express the bank numbers of seven memory banks of the CM 340, and show that by use of the same algorithm as a normal register allotment for each instruction, corresponding bank numbers of the seven memory banks of the CM 340 are allotted.

The “write” interval 2201 expresses the write interval 2001 of FIG. 20. Because there are three threads in which there is “NOP” in the write interval 2202, it shows that there are three intervals to read an NOP instruction. In the same manner, the write interval 2203 shows that there is the instruction of “add l, d, r” only in the first and third threads.

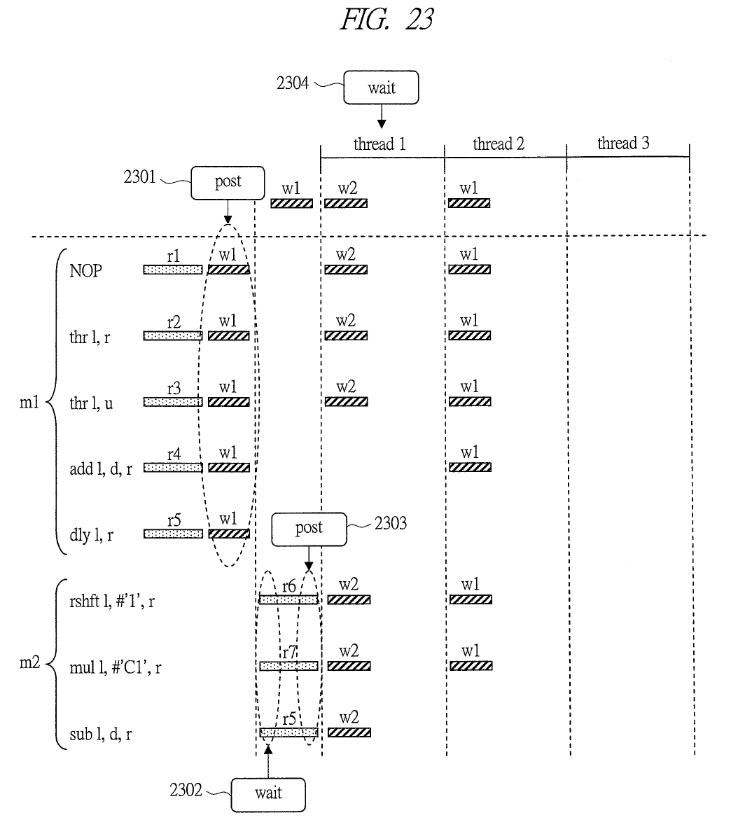

FIG. 23 is a diagram showing an example of the thread interval graph 106 of the result of the scheduling of the load instruction in the CM 340 by the step S807. The post process 2301 and the wait process 2302 are synchronization instructions by the allotment of the same bank number (“5”) as the instruction of “dly l, r” to the instruction “sub l, d, r” in FIG. 22. Thereby, it is guaranteed that while the instruction of “dly l, r” is effective, this data is not overwritten.

The post process 2303 and the wait process 2304 are synchronization instructions to check the end of the load to the instruction of the last three lines. Thereby, it is guaranteed that the configuration of the thread 2 is in the RF 408, when the processor array 301 carries out the thread 2. In addition, “m1” and “m2” at the left end of the diagram shows the instructions that are preferably arranged continuously on the main memory 320, along with this scheduling result.

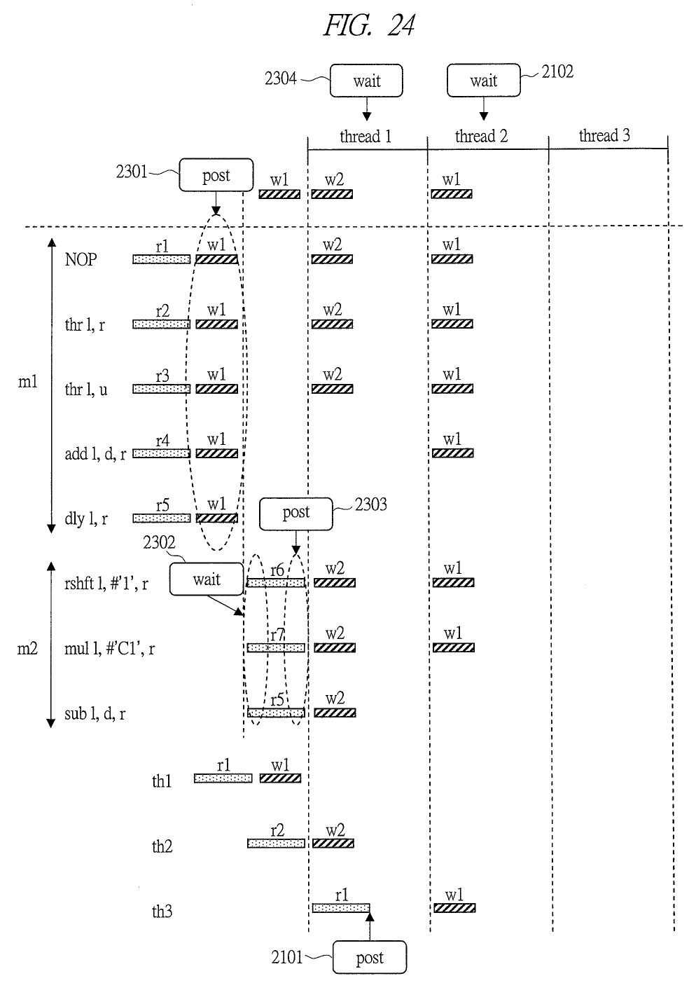

FIG. 24 is a diagram showing a thread interval graph 106 which integrates the thread interval graph 106 for the TM 350 mentioned above and the thread interval graph 106 for the CM 340. Because the CM 340 and the TM 350 are memories to store the data of the different kinds, between these, the process at the steps S706 and S707 to perform the alignment redundancy elimination is not applied. Therefore, the thread interval graph 106 of FIG. 24 is a graph that merely integrates the thread interval graph 106 of FIG. 23 and the thread interval graph 106 of FIG. 21.

FIG. 25 is a diagram showing the final CPU code 130 outputted on the basis of the thread interval graph 106 of FIG. 24, to the source program 110 of FIG. 9. The m1 of the sentence 2502 is a set of the cell configurations corresponding to the m1 in FIG. 24. Herein, the m1 includes the configurations to the first through fifth instructions included in the m1 of FIG. 24 in the order from the top (in the order of r1 to r5).

In the same manner, the m2 of the sentence 2503 is a set of the cell configurations corresponding to the m2 of FIG. 24. The m2 includes the configurations to the first through third instructions included in the m2 of FIG. 24 in the order of the first from the bottom, the first from the top, and the second from the top (in the order of r5, r6, and r7). In the m1 of the sentence 2502, and the m2 of the sentence 2503, the cell configurations of 4 bytes for the respective instructions are stored in the above order.

The sentences 2504 to 2506 are the arrangement in which an initial value is substituted for a pointer to the cell configuration on the instruction pool memory CM 340 for each sentence of each thread code of FIG. 14. The sentence 2507 expresses an instruction to perform the data transfer from the main memory 320 to the TM 350. It shows that the pointer arrangement th1 on the main memory 320 shown by the sentence 2504 is transferred to the first entry on the TM 350.

The sentence 2508 expresses an instruction to perform the data transfer from the main memory 320 to the CM 340. It shows that the arrangement m1 in the main memory 320 shown by the sentence 2502 is transferred, for five elements, to five elements beginning with cm [0] of the arrangement on the CM 340. Thereby, the cell configurations corresponding to the five instructions included in the m1 of FIG. 24 are stored into cm [0] through cm [4] in the above order.

Thereby, the first three elements cm [4], cm [1], and cm [3] of the pointer arrangement th1 of the sentence 2504 indicate the instructions of “′dly l, r”, “thr l, r”, and “add l, d, r” respectively. These instructions correspond to the sentence 1402, the sentence 1403, and the sentence 1404 in the thread code of FIG. 14, respectively. By the above, the pointer arrangement th1 of the sentence 2504 holds the thread code. This is also same to the pointer arrangements th2 and th3 of the sentence 2505 and the sentence 2506.

The sentence 2509 expresses an instruction to perform the data transfer from the CM 340 to the RF 408 by use of the TM 350. It shows that, according to the contents of the pointer arrangement th1, the cell configuration on the CM 340 is transferred to the first entry of the RF 408.

The sentence 2510 expresses an instruction to transfer the pointer arrangement th2 on the main memory 320 shown by the sentence 2505 to the second entry in the TM 350. The sentence 2511 shows that the arrangement m2 on the main memory 320 shown by the sentence 2503 is transferred, for three elements, to the three elements beginning with cm [4] of the arrangement in the CM 340. Thereby, the cell configurations corresponding to the three instructions included in the m2 of FIG. 24 are stored into cm [4] through cm [6] in the above order.

In this process, other data is overwritten to the cm [4] into which data is stored by the sentence 2508, but the contents of this array element cm [4] is already transferred to the RF 408 by the process of the sentence 2509, and accordingly this element on the CM 340 is unnecessary. Therefore, there is no problem even if the data is overwritten to this element cm [4] by the sentence 2511. Thereby, the contents corresponding to the post process 2301 and the wait process 2302 as the synchronization instructions to avoid overwriting to the data loaded in the read interval of the r5 in FIG. 24 are realized, by the sentence 2507 through the sentence 2511.

The sentence 2512 expresses an instruction to transfer the arrangement x on the main memory 320 to the first entry of the local data memory 303, for 500 elements. In the same manner, the sentence 2513 expresses that the arrangement y on the main memory 320 is transferred to the second entry of the local data memory 303, for 500 elements.

The sentence 2514 expresses an instruction to transfer the pointer arrangement th3 in the main memory 320 shown by the sentence 2506 to the first entry on the TM 350. After the data transfer ends, “1” is substituted for the value of the variable flag. The pointer arrangement th1 is transferred to the same entry on the TM 350 by the sentence 2507, but the contents which this arrangement th1 indicates is already transferred to the RF 408 by the sentence 2509, accordingly this entry on the TM 350 is unnecessary. Therefore, there is no problem even if the data is overwritten to this entry by the sentence 2514. The sentence 2515 expresses an instruction to start the sequencer from the first entry of the memory storing the sequencer code 120.

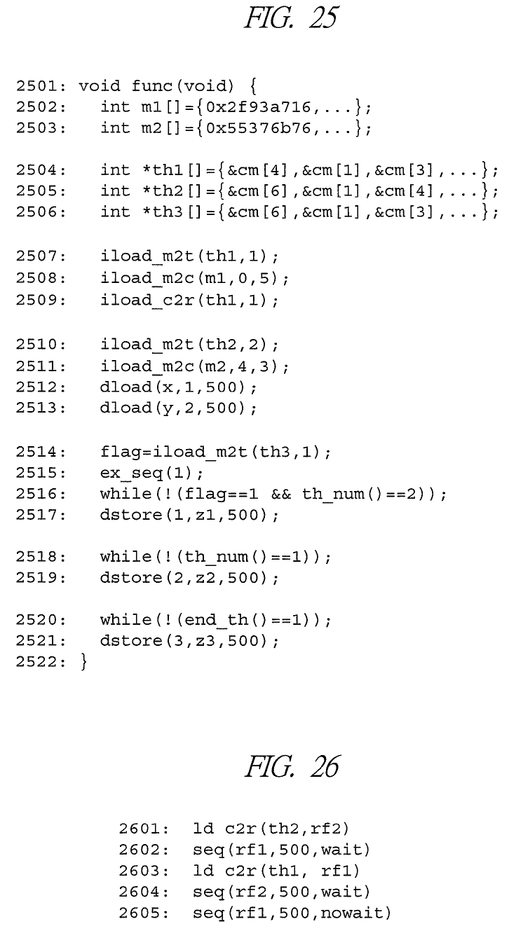

Herein, FIG. 26 is a diagram showing an example of the sequencer code 120 in which the contents of each entry of the sequencer memory 330 are described in the form of the sentence. The sentence 2601 is a code to transfer the configuration to the second entry of the RF 408 by use of the second entry th2 on the TM 350 and the CM 340. Just after the execution of this code, the control goes to the next sentence 2602.

The sentence 2602 is a code to reconfigure the DRP 300 by use of the first entry of the RF 408, and carry out the process for 500 cycles, and after completion of the process, wait for the end of the transfer code of the sentence 2601. By waiting for the end of the process of the sentence 2601 in the sentence 2602, the contents corresponding to the post process 2303 and the wait process 2304 that are the sync instructions in FIG. 24 are realized.

The sentence 2603 and the sentence 2604 perform the same operations as the sentence 2601 and the sentence 2602. By waiting for the end of the process of the sentence 2603 in the sentence 2604, the contents corresponding to the post process 2101 and the wait process 2102 that are sync instructions in FIG. 24 are realized. The sentence 2605 performs the same operation as the sentence 2602, but after the process ends, it does not wait for anything but goes the process of the next sentence. Here, because there is not any sentence to be executed next, the process of the sequencer code 120 is finished, and the process goes back to the process of FIG. 25.

In the sentence 2516 of FIG. 25, the process waits until the value of the variable flag becomes 1, and, the entry number of the RF 408 in which the configuration to the thread under execution in the DRP 300 is stored becomes 2. The condition of the former means that the transfer process of the sentence 2514 has been finished. The sentence 2517 is an instruction to transfer data stored in the entry 1 of the local data memory 303, provided as the result of the process of the thread 1 to the arrangement z1 for 500 elements. Because it can be confirmed that the execution of the thread 1 is finished, and the thread 2 is now performed, by the judgment of the sentence 2516, it is possible to perform this transfer process safely.

In the sentence 2518, the process waits until the entry number of the RF 408 in which the configuration to the thread under execution in the DRP 300 is stored becomes 1. The sentence 2519 is an instruction to transfer the data stored in the entry 2 of the local data memory 303 provided as the result of the process of the thread 2 to the arrangement z2 for 500 elements. Because it can be confirmed that the thread is in the execution by the judgment of the sentence 2516 and the execution of the thread 2 is finished, and the thread 3 is now performed, by the judgment of the sentence 2618, it is possible to perform this transfer process safely.

In the sentence 2520, the process waits until the operation of the DRP 300 is finished. The sentence 2521 is an instruction to transfer the data stored in the entry 3 of the local data memory 303 provided as the result of the process of the thread 3 to the arrangement z3 for 500 elements. By the above, the process corresponding to the source program 110 of FIG. 9 is applied.

Further, in the present embodiment, the compiler 100 for DRP generating an object program to the dynamically reconfigurable processor is explained, but the present invention can be applied to a compiler that generates an object program to a processor having a hierarchical memory system having three addressable hierarchies or more.

Furthermore, in the present embodiment, the compiler 100 for DRP has its constitution to generate an object program, but, for example, another constitution may be made in which the compiler 100 for DRP outputs an assembly language program, and an object program is generated separately by an assembler or a linkage editor. Moreover, before the process by the compiler 100 for DRP, a process may be performed by a preprocessor or the like to the source program 110. It is possible to configure such a series of processes including the compiler 100 for DRP as a tool chain.

As explained above, to the information processing device having the memory CM 340 for pooling instructions to store instructions or configurations to the processor element 3011 and the memory TM 350 for instruction block table to store instruction block tables indicating plural instructions or configurations in the CM 340 in hierarchical memories, the compiler 100 for DRP according to the present embodiment outputs the final CPU code 130 and the sequencer code 120 that is an object program.

This object program transfers instructions or configurations from the main memory 320 that is the lower layer than the CM 340 to the CM 340, and transfers the instruction block table from the main memory 320 that is the lower layer than the TM 350 to the TM 350, and further transfers the instructions or configurations which the instruction block table in the TM 350 indicates, from the CM 340 to the RF 408 which is the memory of the upper layer than this.

Thereby, it is possible to use configurations in common in the CM 340, and the possibility that the part of configurations for reconfiguring a certain function exists in the CM 340 becomes high, and as a result, the possibility to transfer all the configurations from the main memory 320 becomes low, and even if configurations are transferred from the main memory 320, it is possible to perform the transfer in a shorter time than the prior art. Further, the control is taken on the CM 340 so that there is no redundancy of data, and accordingly it is possible to efficiently use hierarchical memories supporting such a data common use.

Furthermore, this object program transfers data from the lower layer of the hierarchical memories to the upper layer step by step, and the insertion of appropriate sync instructions and the instruction scheduling are performed by the compiler 100 for DRP, and necessary data is not sent out automatically like the case of a cache during execution, and further, the data of the upper layer is not overwritten by data transferred from the lower layer during transfer, and accordingly, it is possible to make necessary instructions or configurations exist always on a designated memory when it is necessary in hierarchical memories.

As explained heretofore, the object program generated by the compiler 100 for DRP according to the present embodiment can use the hierarchical memories effectively without performing a cache control in software at execution, and accordingly it is possible to reduce the overhead on the load of instructions and configurations as much as possible, in accelerators such as a DRP having addressable hierarchical memories, and keep the high speed processing performance of the accelerators at the maximum.

While I have shown and described several embodiments in accordance with my invention, it should be understood that disclosed embodiments are susceptible of changes and modifications without departing from the scope of the invention. Therefore, I do not intend to be bound by the details shown and described herein, but intend to cover all such changes and modifications within the ambit of the appended claims.

What is claimed:

1. A compiler inputting a source program, and outputting an object program to operate in an information processing device having hierarchical memories of at least three hierarchies comprising addressable memories, wherein,
with taking the memory close to the processor as the upper layer in the hierarchical memories, a code which transfers instructions or configurations for a processor of the information processing device from the memory of the lower layer to the memory of the upper layer step by step is outputted.

2. The compiler according to claim 1, wherein,
when the processor uses instructions or configurations on a specified memory in the hierarchical memories, a code for controlling so that there are the instructions or configurations to be used exist on the memory is outputted.

3. The compiler according to claim 1, wherein
a code for controlling so that effective data is not be overwritten by the transfer of data between the memories of each hierarchy of the hierarchical memories is outputted.

4. The compiler according to claim 1, wherein
the hierarchical memories that the information processing device in which the object program that the compiler concerned outputs operates has have a memory for pooling instructions to store instructions or configurations for a processor element in the processor, and a memory for instruction block table to store an instruction block table pointing to a plurality of instructions or configurations in the memory for pooling instructions, and
a code for transferring instructions or configurations to the memory for pooling instructions from the memory of the lower layer than the memory for pooling instructions, and a code for transferring the instruction block table to the memory for instruction block table from the memory of the lower layer than the memory for instruction block table are outputted, and
further, a code for transferring the instructions or configurations pointed to by the instruction block table in the memory for instruction block table from the memory for pooling instructions to the memory of the upper layer than the memory for pooling instructions is outputted.

5. The compiler according to claim 4, wherein
a code for controlling so that there are no same ones in the instructions or configurations occurs in the memory for pooling instructions is outputted.

6. The compiler according to claim 4, wherein
the memory allocation of the instructions or configurations to the memory for pooling instructions is performed by regarding the time from the transfer start to the transfer end of the instructions or configurations from the memory for pooling instructions to the memory of the upper layer, as a memory occupancy period of the instructions or configurations concerned.

7. The compiler according to claim 1, wherein
a code for transferring instructions or configurations from the memory of the lower layer to the memory of the upper layer in the hierarchical memories step by step is obtained by applying the memory allocation and an instruction scheduling to a transfer instruction sequentially, from the memory of the upper layer to the memory of the lower layer in the hierarchical memories.

8. The compiler according to claim 7, wherein
the memory allocation of the memory of the lower layer is performed by regarding the period from the execution start to the execution end of the transfer instruction from the memory of the lower layer to the memory of the upper layer, obtained as the result of the instruction scheduling of the memory of the upper layer in the hierarchical memories, as a memory occupancy period in the memory of the lower layer.

9. The compiler according to claim 1, wherein
the processor of the information processing device in which the object program that the compiler concerned outputs operates is a dynamically reconfigurable processor.

10. A tool chain including the compiler according to claim 1.
